(19) United States
(12) Patent Application Publication
(10) Pub. No.: US 2008/0071029 A1
(43) Pub. Date: Mar. 20, 2008

(54) RESIN COMPOSITION

(75) Inventor: Naoyuki Ono, Chuo-ku (JP)

Correspondence Address: DARBY & DARBY P.C., P.O. BOX 770, Church Street Station, New York, NY, 10008-0770, US

(73) Assignee: RIKEN TECHNOS CORPORATION, Chuo-ku (JP)

(21) Appl. No.: 11/533,073

(22) Filed: Sep. 19, 2006

(51) Int. Cl. C08F 8/00

(52) U.S. Cl. 525/145

(57) ABSTRACT

PURPOSE: The present invention provides a resin composition which can be used in cross-linking of rubber and in dynamic cross-linking of thermoplastic elastomers, wherein it is easy to handle and can yield homogeneous cross-linking, and can improve compression set and molding processability of a cross-linked elastomer composition obtained by cross-linking, such as cross-linked rubber compositions and cross-linked thermoplastic elastomer compositions.

CONSTITUTION: The resin composition according to the present invention comprises
(a) 100 parts by weight of at least one compound selected from the group consisting of phenolic resins and brominated phenolic resins,
(b) 20 to 500 parts by weight of a crystalline olefine resin other than copolymers of ethylene with an unsaturated carboxylic acid ester or with vinyl acetate,
(c) 20 to 300 parts by weight of a non-aromatic softening agent for rubber, and
(d) 10 to 100 parts by weight of at least one polymer selected from the group consisting of a copolymer of a vinyl aromatic compound with a conjugated diene compound, a hydrogenated copolymer obtained by hydrogenating said copolymer, and a hydrogenated polymer obtained by hydrogenating a polymer of a conjugated diene compound.

### FIELD OF THE INVENTION

The present invention relates to a resin composition comprising a phenolic resin-based cross-linking agent. Particularly, the present invention relates to a resin composition which may be used in cross-linking of rubber and in dynamic cross-linking of thermoplastic elastomers, and is easy to handle and can yield homogeneous cross-linking, and can improve compression set and molding processability of cross-linked rubber compositions or cross-linked thermoplastic elastomer compositions obtained by cross-linking. Further, the present invention relates to a cross-linked elastomer composition such as a cross-linked rubber composition and a cross-linked thermoplastic elastomer composition comprising this resin composition.

### BACKGROUND OF THE INVENTION

In recent years, much use have been made of thermoplastic elastomers which are soft materials with rubber elasticity, do not require a vulcanization process, have molding processability similar with that of thermoplastic resins and are recyclable in fields such as automobile parts, light electric appliance parts, wire coverings, medical device components, footwear, and miscellaneous goods.

Among the thermoplastic elastomers, styrenic thermoplastic elastomers such as a styrene-butadiene block copolymer (SBS) and a styrene-isoprene block copolymer (SIS) which are copolymers of a vinyl aromatic compound with a conjugated diene compound have high flexibility and good rubber elasticity at ambient temperature. In addition, thermoplastic elastomer compositions obtainable from these elastomers are excellent in processability and are widely used as a substitute for vulcanized rubber.

Further, many thermoplastic elastomer compositions which are obtained by dynamically cross-linking a composition comprising an olefin resin and an olefine copolymer rubber are known to improve compression set and oil resistance at high temperatures. In these thermoplastic elastomers, rubber which undergoes cross-linking with a phenolic resin is widely employed as a rubber component.

However, such phenolic resins are hard and brittle, and form dust in handling. Accordingly, they are difficult to handle when used solely in dynamic cross-linking. Further, phenolic resins start melting at approximately 80° C., depending on melt kneading conditions at dynamic cross-linking. Therefore, they tend to stick to a wall surface of a kneader and, in the end, get scorched by heat from the wall surface of the kneader. This also renders them very difficult to handle.

Further, phenolic resins start degrading in a temperature range of 160° C. or higher to emit toxic gases such as formaldehyde which are concerned to adversely affects a human body. Therefore, if a phenolic resin is used alone in dynamic cross-linking of a thermoplastic elastomer, a rapidly heated phenolic resin emits toxic gases to make an operator complain of pains in eyes or noses.

Therefore, it is proposed to use a masterbatch of a phenolic resin. However, the form of it supplied is not pellets, but plates, and is unsuitable for use in melt kneading with a thermoplastic elastomer or kneading with rubber.

Further, rubber such as butyl rubber that undergoes cross-linking with a phenolic resin is used as a main component in such masterbatches of a phenolic resin. Therefore, if such a masterbatch is used in kneading with a thermoplastic elastomer, cross-linking of rubber in the masterbatch take place in advance of dispersion of the masterbatch to prevent uniform cross-linking of the overall mixture under kneading (see, for example, Literature 1).

The following literature may be mentioned as the prior art:

1. Japanese Patent Application Laid-Open No. 9-12839/1997.

### DISCLOSURE OF THE INVENTION

It is an object of the present invention to provide a resin composition comprising a phenolic resin-based cross-linking agent, which resin composition is easy to handle and does not have the aforesaid drawbacks in cross-linking of rubber and in dynamic cross-linking of thermoplastic elastomers.

Thus, the present invention provides

(1) a resin composition characterized in that it comprises

(a) 100 parts by weight of at least one compound selected from the group consisting of phenolic resin and brominated phenolic resins,
(b) 20 to 500 parts by weight of a crystalline olefine resin other than copolymers of ethylene with an unsaturated carboxylic acid ester or with vinyl acetate,
(c) 20 to 300 parts by weight of a non-aromatic softening agent for rubber, and
(d) 10 to 100 parts by weight of at least one polymer selected from the group consisting of a copolymer of a vinyl aromatic compound with a conjugated diene compound, a hydrogenated copolymer obtained by hydrogenating the aforesaid copolymer, and a hydrogenated polymer obtained by hydrogenating a polymer of a conjugated diene compound.

As preferred embodiments of the present invention, there may be mentioned:

(2) a resin composition according to the aforesaid (1), wherein component (b) is at least one selected from the group consisting of an ethylene homopolymer, a propylene homopolymer, an ethylene-α-olefin copolymer and a propylene-α-olefin copolymer, (3) a resin composition according to any one of the aforesaid (1) and (2), wherein component (a) is an alkylphenol-formaldehyde resin, and
(4) a resin composition according to any one of the aforesaid (1) to (3), wherein it further comprises (e) a cross-linking accelerator in an amount of 200 parts by weight or less.

Further, the present invention provides:

(5) a cross-linked elastomer composition characterized in that it comprises 100 parts by weight of rubber and 1 to 200 parts by weight of the resin composition according to any one of the aforesaid (1) to (4).

As preferred embodiments of the present invention, there may be mentioned:

(6) a composition according to the aforesaid (5), wherein it further comprises a crystalline olefine resin in an amount of 400 parts by weight or less,
(7) a composition according to any one of the aforesaid (5) and (6), wherein it further comprises a cross-linking accelerator in an amount of 200 parts by weight or less per 100 parts by weight of component (a) with the proviso that, when the resin composition comprises component (e), a total of the amounts including component (e) is 200 parts by weight or less based on 100 parts by weight of component (a),
(8) a composition according to any one of the aforesaid (5) to (7) wherein it further comprises a non-aromatic softening agent for rubber in an amount of 800 parts by weight or less,
(9) a composition according to any one of the aforesaid (5) to (8), wherein it further comprises at least one polymer selected from the group consisting of a copolymer of a vinyl aromatic compound with a conjugated diene compound, a hydrogenated copolymer obtained by hydrogenating the aforesaid copolymer, and a hydrogenated polymer obtained by hydrogenating a polymer of a conjugated diene compound in an amount of 200 parts by weight or less, and
(10) a composition according to any one of the aforesaid (5) to (9), wherein it further comprises 0.01 to 0.5 part by weight of an organic peroxide.

The resin composition according to the present invention can be used in cross-linking of rubber and in dynamic cross-linking of thermoplastic elastomers, wherein it is easy to handle and can yield homogeneous cross-linking, and can improve compression set and molding processability of a cross-linked elastomer composition obtained by cross-linking, such as cross-linked rubber compositions and cross-linked thermoplastic elastomer compositions.

### PREFERRED EMBODIMENTS OF THE INVENTION

The components for the resin composition according to the present invention and the production of the composition as well as the thermoplastic elastomer composition as a cross-linked elastomer composition obtained from this resin composition and its applications will be elucidated below. Further, the resin composition according to the present invention is useful also as a master batch of a cross-linking agent for rubber and is suitably used for cross-linking rubber as well as for dynamic cross-linking thermoplastic elastomers. The following explanation is directed to the use in dynamic cross-linking of thermoplastic elastomers and thermoplastic elastomer compositions obtained thereby, but the present invention also covers the use of the resin composition according to the present invention in cross-linking rubber and cross-linked rubber compositions obtained thereby.

### 1. Components of the Resin Composition

### Component (a):

Component (a) is at least one compound selected from the group consisting of phenolic resins and brominated phenolic resins. As Component (a), use may be made of any phenolic resins and brominated phenolic resins that are capable of cross-linking rubber.

Component (a) is preferably a phenolic resin having the formula (I)

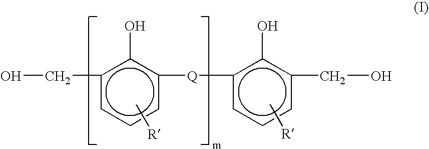

wherein Q is a divalent group selected from the group consisting of —CH₂— and —CH₂—O—CH₂—, m is 0 or a positive integer of 1 to 20, and R′ is an organic group, or such a phenolic resin whose terminal hydroxyl group(s) is (are) brominated. Preferably, Q is a divalent group, —CH₂—O—CH₂—, m is 0 or a positive integer of 1 to 10, and R′ is an organic group having less than 20 carbon atoms. More preferably, m is 0 or a positive integer of 1 to 5, and R′ is an organic group having 4 to 12 carbon atoms.

Among the aforesaid phenolic resins, more preferred are an alkylphenol-formaldehyde resin, a methylolated alkylphenolic resin and a brominated alkylphenolic resin. Particularly preferred is an alkylphenol-formaldehyde resin.

The aforesaid phenolic resins may be produced in a usual method, for example, by condensing alkyl-substituted phenol or non-substituted phenol with, preferably, formaldehyde in an alkaline medium or by condensing bifunctional phenol-dialcohol. Commercially available phenolic resins may also be used.

Examples of the commercially available phenolic resin products are Tackrol 201 (alkylphenol-formaldehyde resin ex Taoka Chemical Co.), Tackrol 250-I (brominated alkylphenol-formaldehyde resin with 4% of bromination, ex Taoka Chemical Co.), Tackrol 250-III (brominated alkylphenol-formaldehyde resin ex Taoka Chemical Co.), PR-4507 (ex Gun Ei Chemical Co.), Vulkaresat 510E (ex Hoechst Co.), Vulkaresat 532E (ex Hoechst Co.), Vulkaresen E (ex Hoechst Co.), Vulkaresen 105E (ex Hoechst Co.), Vulkaresen 130E (ex Hoechst Co.), Vulkaresol 315E (ex Hoechst Co.), Amberol ST 137X (ex Rohm & Haas Co.), Sumilite Resin PR-22193 (ex Sumitomo Durez Co.), Symphorm-C-100 (ex Anchor Chemical Co.), Symphorm-C-1001 (ex Anchor Chemical Co.), Tamanol 531 (ex Arakawa Chemical Co.), Schenectady SP1059 (ex Schenectady Chemical Co.), Schenectady SP1045 (ex Schenectady Chemical Co.), CRR-0803 (ex Union Carbide Corp.), Schenectady SP1055 (ex Schenectady Chemical Co.), Schenectady SP1056 (ex Schenectady Chemical Co.), CRM-0803 (ex showa Union Gosei Co.) and Vulkadur A (ex Bayer Co.). Among them, preferably used is Tackrol 201 (alkylphenol-formaldehyde resin).

### Component (b):

Component (b) is a crystalline olefine resin. This does not react with Component (a) which is a cross-linking agent. Accordingly, where dynamic cross-linking of a thermoplastic elastomer is carried out using the resin composition according to the present invention as a masterbatch of a phenolic resin-based cross-linking agent, no cross-linking takes place in the masterbatch in advance of dispersion of the masterbatch. Hence uniform cross-linking can be achieved, compared to that with a phenolic resin masterbatch comprising butyl rubber.

Examples of Component (b) include a homopolymer of an olefin such as ethylene, propylene, butene-1 and 4-methyl-pentene-1, and a copolymer composed mainly of these olefins. However, a copolymer of ethylene with an unsaturated carboxylic acid ester or with vinyl acetate is not preferred, because it has problems that it is sticky in melt processing and adheres heavily to metals or a kneader due to its polarity, tends to suffer burns and has an odor, leading to poorer productivity of the resin composition according to the present invention; even if the resin composition can be produced it may cause blocking; if the resin composition thus obtained is used for dynamically cross-linking a thermoplastic elastomer, the thermoplastic elastomer composition obtained will have poorer compression set and a shaped article therefrom tends to yield hard spots. Accordingly, Component (b), crystalline olefine resin, is not a copolymer of ethylene with an unsaturated carboxylic acid ester or with vinyl acetate.

As Component (b), there are particularly mentioned a homopolymer of ethylene or propylene, or a crystalline copolymer composed mainly of ethylene or propylene. Specifically mentioned are crystalline ethylenic polymers such as high density polyethylene, low density polyethylene and ethylene-α-olefin copolymer, a propylene homopolymer and a crystalline propylene copolymer such as propylene-α-olefin copolymer. Here, α-olefins used in a copolymer of ethylene or propylene include α-olefins having 2 to 10 carbon atoms, for example, ethylene, propylene, butene-1, hexene-1,4-methyl-pentene-1,3-methyl-pentene-1 and octene-1. As the crystalline copolymers composed mainly of ethylene or propylene, there are mentioned crystalline ethylene polymers such as an ethylene-butene-1 copolymer, ethylene-hexene-1 copolymer and ethylene-octene-1 copolymer and crystalline propylene polymers such as a propylene-ethylene random copolymer, propylene-ethylene block copolymer, propylene-ethylene random block copolymer, propylene-butene-1 copolymer and propylene-ethylene-butene-1 terpolymer.

Ziegler-Natta catalysts and metallocene catalysts may be used as synthesizing Component (b).

Ethylene resins synthesized with a metallocene catalyst is preferred as Component (b) for its compatibility with rubber. When a thermoplastic elastomer in which rubber is dispersed in a polypropylene (PP) matrix, polypropylene is also preferred as Component (b), because it allows the cross-linking to proceed while maintaining the structure where rubber is dispersed completely in the PP matrix.

A melting point as determined by DSC of Component (b) is preferably 30 to 180° C., more preferably 40 to 170° C. Here, a melting point as determined by DSC refers to a peak top melting point determined by a differential scanning calorimeter (DSC). Specifically, it is a value measured with a DSC by taking a sample amount of 10 mg, holding the sample at 190° C. for 5 minutes, then cooling the sample down to −10° C. at a cooling speed of 10° C./min. to crystallize, holding the sample at −10° C. for 5 minutes, and doing scanning up to 200° C. at a heating speed of 10° C./min.

The amount of Component (b) in the formulation is 20 to 500 parts by weight, preferably 80 to 350 parts by weight per 100 parts by weight of Component (a). If it exceeds 500 parts by weight, compression set of the thermoplastic elastomer composition obtained will be worse. If it is less than 20 parts by weight, the productivity and anti-blocking property of the resin composition will be worse.

### Component (c):

Component (c) is a non-aromatic softening agent for rubber and is preferably paraffin oil. For example, paraffinic compounds having 4 to 155 carbon atoms, preferably 4 to 50 carbon atoms, are mentioned. More specifically mentioned are n-paraffins (saturated linear hydrocarbons) such as butane, pentane, hexane, heptane, octane, nonane, decane, undecane, dodecane, tetradecane, pentadecane, hexadecane, heptadecane, octadecane, nonadecane, eicosane, heneicosane, docosane, tricosane, tetracosane, pentacosane, hexacosane, heptacosane, octacosane, nonacosane, triacontane, hentriacontane, dotriacontane, pentatriacontane, hexacontane and heptacontane; isoparaffins (saturated branched hydrocarbons) such as isobutane, isopentane, neopentane, isohexane, isopentane, neohexane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethylpentane, 2,2,3-trimethylbutane, 3-methylheptane, 2,2-dimethylhexane, 2,3-dimethylhexane, 2,4-dimethylhexane, 2,5-dimethylhexane, 3,4-dimethylhexane, 2,2,3-trimethylpentane, isooctane, 2,3,4-trimethylpentane, 2,3,3-trimethylpentane, 2,3,4-trimethylpentane, isononane, 2-methylnonane, isodecane, iso-undecane, isododecane, isotridecane, isotetradecane, isopentadecane, iso-octadecane, isonanodecane, iso-eicosane and 4-ethyl-5-methyloctane; and derivatives of these saturated hydrocarbons. Of these paraffin oils, those which are liquid at room temperature are preferred. The paraffin oil may be used alone or in a mixture of more than two of them.

Commercially available paraffin oils which are liquid at room temperature include NA Solvent (isoparaffinic hydrocarbon oil) ex Nippon Fats & Oils Co., PW-90 and PW-380 (n-paraffinic process oil) ex Idemitsu Kosan Co., IP-Solvent 2835 (synthetic isoparaffinic hydrocarbon composed with 99.8% by weight or more of isoparaffins) ex Idemitsu Petrochemical Co., and Neothiozol (n-paraffinic process oil) ex Sanko Chemical Co.

A small amount of unsaturated hydrocarbons or derivatives therefrom may be present in the paraffin oil. As the unsaturated hydrocarbons, there may be mentioned ethylene type of hydrocarbons such as ethylene, propylene, 1-butene, 2-butene, isobutylene, 1-pentene, 2-pentene, 3-methyl-1-butene, 3-methyl-1-butene, 2-methyl-2-butene, 1-hexene, 2,3-dimethyl-2-butene, 1-heptene, 1-octene, 1-nonene and 1-decene; and acetylene type of hydrocarbons such as acetylene, methylacetylene, 1-butyne, 2-butyne, 1-pentyne, 1-hexyne, 1-octyne, 1-nonyne and 1-decyne.

Component (c) preferably has a kinetic viscosity at 37.8° C. of 20 to 500 cSt, a pour point of −10 to −15° C., and a flash point (COC) of 170 to 300° C.

The amount of Component (c) in the formulation is 20 to 300 parts by weight, preferably 80 to 200 parts by weight based on 100 parts by weight of Component (a). If it exceeds 300 parts by weight, breeding-out of the oil is more evident and anti-blocking property of the resin composition is worse. If it is less than 20 parts by weight, the productivity of the resin composition is worse.

### Component (d):

Component (d) is at least one polymer selected from the group consisting of a copolymer of a vinyl aromatic compound with a conjugated diene compound (d-1), a hydrogenated copolymer (d-2) obtained by hydrogenating the copolymer (d-2), and a hydrogenated polymer obtained by hydrogenating a polymer of a conjugated diene compound (d-3). Because Component (d) has a higher molecular weight, it can enhance viscosity during the production of the resin composition, making kneading possible at lower temperature. As a result, it is possible to prevent the phenolic resin from getting sticky and adhering to the kneader. Thermal degradation of the phenolic resin can also be prevented and, hence, the resin composition having good crosslinkability can be obtained so that compression set of the thermoplastic elastomer composition is improved.

The copolymer (d-1) includes a random copolymer of a vinyl aromatic compound with a conjugated diene compound (d-1-1), and a block copolymer of a vinyl aromatic compound with a conjugated diene compound (d-1-2). The vinyl aromatic compound to compose these copolymers may be one or more selected from, for example, styrene, t-butylstyrene, α-methylstyrene, p-methylstyrene, divinylbenzene, 1,1-diphenylstyrene, N,N-diethyl-p-aminoethylstyrene, vinyltoluene and p-tert.-butylstyrene. Styrene is especially preferred. The conjugated diene compound may be one or more selected from, for example, butadiene, isoprene, 1,3-pentadiene and 2,3-dimethyl-1,3-butadiene. Butadiene, isoprene and a combination thereof are especially preferred.

The aforesaid random copolymer (d-1-1) is composed of 3 to 60 parts by weight, preferably 5 to 50 parts by weight, of the vinyl aromatic compound. Its number average molecular weight is preferably in the range of 150,000 to 500,000, more preferably of 170,000 to 400,000, still more preferably 200,000 to 350,000, and its molecular weight distribution is 10 or less.

A specific example of the aforesaid random copolymer (d-1-1) is a copolymer of styrene with butadiene (SBR).

The aforesaid block copolymer (d-1-2) is composed of at least two polymeric blocks (A) composed mainly of a vinyl aromatic compound, and at least one polymeric block (B) composed mainly of a conjugated diene compound. For example, a vinyl aromatic compound-conjugated diene compound block copolymer having a structure, A-B-A, B-A-B-A or A-B-A-B-A may be mentioned. The aforesaid block copolymer comprises 5 to 60% by weight, preferably 20 to 50% by weight, of a vinyl aromatic compound.

Preferably, the polymeric block (A) composed mainly of a vinyl aromatic compound consists solely of a vinyl aromatic compound, or is a copolymeric block of at least 50% by weight, more preferably at least 70% by weight, of a vinyl aromatic compound and a conjugated diene compound.

Preferably, the polymeric block (B) composed mainly of a conjugated diene compound consists solely of a conjugated diene compound or is a copolymeric block of at least 50% by weight, more preferably at least 70% by weight, of a conjugated diene compound and a vinyl aromatic compound.

A number average molecular weight of the aforesaid block copolymer (d-1-2) is preferably in the range of 5,000 to 1,500,000, more preferably 10,000 to 550,000, still more preferably 100,000 to 400,000 and its molecular weight distribution is 10 or less. Molecular structure of the block copolymer may be linear, branched, radial or any combination thereof.

Further, in both the polymeric block (A) composed mainly of a vinyl aromatic compound and the polymeric block (B) composed mainly of a conjugated diene compound, a distribution of units derived from a conjugated diene compound or a vinyl aromatic compound in a molecular chain may be at random, tapered (i.e., a content of the monomeric component increases or decreases along a molecular chain.), in the form of partial block or any combination thereof. When two or more of the polymeric block (A) composed mainly of a vinyl aromatic compound or two or more of the polymeric block (B) composed mainly of a conjugated diene compound are present, they may be same with or different from each other in structure.

Examples of the aforesaid block copolymer (d-1-2) include styrene-butadiene-styrene copolymer (SBS) and styrene-isoprene-styrene copolymer (SIS).

A number of methods were proposed for the preparation of the aforesaid block copolymer (d-1-2). In JP Publication 40-23798/1965 as a typical example, this may be obtained by carrying out block-polymerization with a lithium catalyst or a Ziegler catalyst in an inert medium.

The aforesaid hydrogenated copolymer (d-2) includes a hydrogenated copolymer (d-2-1) of the aforesaid random copolymer (d-1-1) and a hydrogenated copolymer (d-2-2) of the aforesaid block copolymer (d-1-2).

The hydrogenated copolymer (d-2-1) is a hydrogenated random copolymer obtained by hydrogenating the aforesaid random copolymer (d-1-1).

The hydrogenated copolymer (d-2-1) preferably has a melt mass flow rate (as measured at 230° C. with a load of 21.18 N according to ASTM D 1238) of 12 g/10 minute or less, more preferably 6 g/10 minute or less in view of a tensile property and heat distortion resistance.

A content of a vinyl aromatic compound in the hydrogenated copolymer (d-2-1) is preferably 25% by weight or less, more preferably 20% by weight or less, for the purpose of obtaining a flexible thermoplastic elastomer composition. Also for the same purpose, those are preferred in which at least 90%, preferably 100%, of carbon-carbon double bonds in the conjugated diene compound are hydrogenated.

As an example of the hydrogenated copolymer (d-2-1) Dynalon 1320P (ex JSR Co.) is mentioned.

The hydrogenated copolymer (d-2-2) is a hydrogenated block copolymer obtained by hydrogenating the aforesaid block copolymer (d-1-2).

A hydrogenation ratio in the hydrogenated copolymer (d-2-2) may be optional, but is preferably 50% or more, more preferably 55% or more, still more preferably 60% or more, in the polymeric block (B) composed mainly of a conjugated diene compound. The microstructure of the polymeric block (B) may be optional. For example, where the block (B) is composed solely of butadiene, 1,2-micro structure accounts preferably for 20 to 50% by weight, particularly preferably 25 to 45% by weight, of the polybutadiene block. The 1,2-bonds may selectively be hydrogenated. In a case where the block (B) is composed of a mixture of isoprene and butadiene, the 1,2-micro structure accounts preferably for less than 50% by weight, more preferably less than 25% by weight, and still more preferably less than 15% by weight.

Where the block (B) is composed solely of isoprene, it is preferred that 70 to 100% by weight of isoprene in the polyisoprene block has 1,4-micro structure and at least 90% of the aliphatic double bonds derived from isoprene is hydrogenated

It is preferred that the polymeric block (A) is of 5 to 70% by weight of the overall hydrogenated copolymer (d-2-2). The weight average molecular weight of the overall hydrogenated copolymer (d-2-2) is preferably 150,000 to 500,000, more preferably 200,000 to 400,000. If the weight average molecular weight is less than 200,000, breeding-out of oil occurs.

Examples of the hydrogenated copolymer (d-2-2) include styrene-ethylene-butene copolymer (SEB), styrene-ethylene-propylene copolymer (SEP), styrene-ethylene-butene-styrene copolymer (SEBS), styrene-ethylene-propylene-styrene copolymer (SEPS), styrene-ethylene-ethylene-propylene-styrene copolymer (SEEPS) and styrene-butadiene-butylene-styrene copolymer (partially hydrogenated styrene-butadiene-styrene copolymer, SBBS).

Among them, styrene-ethylene-ethylene-propylene-styrene copolymer (SEEPS) is most preferred in that it is excellent in giving flexibility and causes very little breeding-out of oil.

The hydrogenated copolymer (d-2-2) is produced by hydrogenation of the aforesaid block copolymer (d-1-2). The hydrogenation may be carried out in any publicly known method, for example, in an inert solvent in the presence of a hydrogenation catalyst.

The hydrogenated polymer (d-3) is obtained by hydrogenating a polymer of a conjugated diene compound and may be, for example, a block copolymer (CEBC) having a crystalline ethylene block and an amorphous ethylene-butene block, as obtained by hydrogenating a polymer of butadiene. The hydrogenated polymer (d-3) may be used alone or as a mixture of two or more of such.

A weight average molecular weight of the hydrogenated polymer (d-3) is preferably 500,000 or less, more preferably 200,000 to 450,000. If the weight average molecular weight exceeds 500,000, extrusion or injection molding processability of the thermoplastic elastomer composition to be obtained is worse. If the weight average molecular weight is less than 200,000, breeding-out of oil occurs and compression set of the thermoplastic elastomer composition to be obtained is worse.

Among the aforesaid polymers, the hydrogenated copolymer (d-2-2) is preferred in that it is excellent in giving flexibility and causes very little breeding-out of oil. Especially styrene-ethylene-ethylene-propylene-styrene copolymer (SEEPS) is more preferred. Particularly, SEPTON 4077 and 4055 (ex Kuraray Co.) are most preferred because of their molecular weight.

The amount of Component (d) in the formulation is 10 to 100 parts by weight, preferably 10 to 80 parts by weight, per 100 parts by weight of Component (a). If it exceeds 100 parts by weight, productivity of the resin composition will be worse. If it is less than 10 parts by weight, a melt kneading temperature in the production of the resin composition will be higher and, as a result, compression set of the thermoplastic elastomer composition obtained will be worse.

### Component (e) (Optional Component):

Component (e) is a cross-linking accelerator and is used as an optional component to more effectively improve the function of Component (a) as an cross-linking agent. Examples for Component (e) include zinc oxide, magnesium oxide and tin dichloride. Where zinc oxide is used as Component (e), a metal salt of stearic acid as dispersant may be used together. Among the aforesaid cross-linking accelerators, zinc oxide is particularly preferred.

The amount of Component (e) to be dosed is 200 parts by weight or less, preferably 0.3 to 200 parts by weight, more preferably 0.3 to 150 parts by weight, still more preferably 0.5 to 80 parts by weight, per 100 parts by weight of Component (a). If it exceeds the aforesaid upper limit, compatibility of the resin composition with rubber or other components in the production of the thermoplastic elastomer compositions will be worse, and the effects of improving the compression set and molding processability of the thermoplastic elastomer composition will be less.

### 2. Production of the Resin Composition

The resin composition according to the present invention may be produced by adding and melt kneading, simultaneously or in any order, the aforesaid Components (a) to (d) and, optionally, Component (e). A method for the melt kneading is not particularly limited, but may be any one of publicly known methods, such as, for example, single-screw extruders, twin-screw extruders, rolls, Bunbary mixers and various kneaders. The above said operations may be carried out successively using, for example, a twin-screw extruder, Bunbary mixer or press kneader with appropriate L/D. Here, a temperature In the melt kneading is preferably 70 to 250° C.

The resin composition thus produced can be easily pelletized and be used as a masterbatch of a cross-linking agent in dynamic cross-linking of thermoplastic elastomers. The resin composition according to the present invention is easy to handle in the production of thermoplastic elastomer compositions and can yield homogeneous cross-linking (i.e., not to cause hard spots in an articles shaped from the aforesaid thermoplastic elastomer compositions), and can improve compression set and molding processability of the thermoplastic elastomer compositions obtained.

### 3. Thermoplastic Elastomer Composition

The thermoplastic elastomer composition according to the present invention is obtained by adding to rubber the resin composition thus obtained and, if required, other components and melt kneading them. The amount of the resin composition is 1 to 200 parts by weight, preferably 5 to 100 parts by weight, more preferably 10 to 50 parts by weight, per 100 parts by weight of the rubber. If the amount of the resin composition exceeds the upper limit, whitening on bending or fatigue on bending of the thermoplastic elastomer composition obtained will be worse. A method for the melt kneading may be same as those described for the production of the resin composition.

As the rubber, there are mentioned ethylene copolymeric rubber (EPDM and the like), butadiene rubber (BR), butyl rubber (IIR) and nitrile rubber (NBR). Especially ethylene copolymeric rubber (EPDM and the like) is preferred.

The aforesaid ethylene copolymeric rubber includes, for example, copolymers of ethylene with an α-olefin such as propylene, 1-butene and 1-pentene, and copolymers of one of these monomers with a non-conjugated polyene.

As the aforesaid non-conjugated polyene, a non-conjugated diene is preferred, such as 5-ethyliden-2-norbornene (ENB), 1,4-hexadiene, 5-methylene-2-norbornene (MNB), 1,6-octadiene, 5-methyl-1,4-hexadiene, 3,7-dimethyl-1,6-octadiene, 1,3-cyclopentadiene, 1,4-cyclohexadiene, tetrahydroindene, methyl tetrahydroindene, dicyclopentadiene, 5-isopropyliden-2-norbornene, 5-vinyl-norbornene, dicyclooctadiene and methylenenorbornene.

Examples of the ethylene copolymeric rubber include ethylene-propylene copolymeric rubber, ethylene-propylene-non-conjugated diene copolymeric rubber, ethylene-1-butene copolymeric rubber, ethylene-1-butene-non-conjugated diene copolymeric rubber and ethylene-propylene-1-butene copolymeric rubber. Ethylene-propylene-non-conjugated diene copolymeric rubber (EPDM) is preferred because of its cross-linking property with a phenolic resin.

A catalyst to be used for the synthesis of ethylene copolymeric rubber may be a Ziegler catalyst and a metallocene catalyst. Particularly a metallocene catalyst is preferred because ethylene copolymeric rubber prepared using it has uniform composition, and yields uniform cross-linking (the latter is particularly true when a non-conjugated polyene compound is incorporated, as a content of the non-conjugated polyene compound is constant).

An ethylene content in the ethylene copolymeric rubber is preferably in the range of 40 to 80% by weight, more preferably of 50 to 75% by weight. Particularly the range of 60 to 75% by weight is preferred, as balance is good between productivity and compression set and/or tensile strength at a high temperature of the thermoplastic elastomer composition obtained. A content of the non-conjugated polyene is preferably 0.5 to 8% by weight, more preferably 4 to 8% by weight. The ethylene copolymeric rubber preferably has a Mooney viscosity, ML₁₊₄ (125° C.), of 10 to 180, more preferably 20 to 160. If the Mooney viscosity, ML₁₊₄ (125° C.), is lea then 10, compression set of the thermoplastic elastomer composition obtained will be worse. If it exceeds 180, moldability will be worse.

The thermoplastic elastomer composition according to the present invention may comprise, if required, a crystalline olefine resin. The crystalline olefine resin is employed for the purpose of adjusting hardness, improving moldability and yielding heat resistance in the thermoplastic elastomer composition. Examples of the aforesaid crystalline olefine resin include homopolymers of an olefin such as ethylene, propylene, butene-1 and 4-methylpentene-1, or copolymers composed mainly of these olefins. Among them, particularly mentioned are homopolymers of ethylene or propylene, or crystalline copolymers composed mainly of ethylene or propylene, more specifically crystalline ethylenic polymers such as high density polyethylene, low density polyethylene and ethylene-α-olefin copolymer; and propylene homopolymers and crystalline propylene copolymers such as propylene-α-olefin copolymer. Here, the α-olefin to be used in the copolymer with ethylene or propylene includes α-olefins of 2 to 10 carbon atoms such as ethylene, propylene, butene-1, hexene-1,4-methylpentene-1,3-methylpentene-1 and octene-1. The crystalline copolymer composed mainly of ethylene or propylene includes crystalline ethylene polymers such as ethylene-butene-1 copolymers, ethylene-hexene-1 copolymers and ethylene-octene-1 copolymers; and crystalline propylene polymers such as propylene-ethylene random copolymers, propylene-ethylene block copolymers, propylene-ethylene random block copolymers, propylene-butene-1 copolymers and propylene-ethylene-butene-1 terpolymers.

The amount of the aforesaid crystalline olefine resin is 400 parts by weight or less, preferably 250 parts by weight or less, more preferably 200 parts by weight or less, per 100 parts by weight of the rubber. Also, the aforesaid amount is preferably at least 10 parts by weight, more preferably at least 20 parts by weight, still more preferably at least 30 parts by weight, per 100 parts by weight of the rubber. If it exceeds 400 parts by weight, compression set or flexibility of the thermoplastic elastomer composition obtained is worse.

The thermoplastic elastomer composition according to the present invention may comprise, if required, a cross-linking accelerator. The cross-linking accelerator may be those described as Component (e) for the aforesaid resin composition. Zinc oxide is particularly preferred.

The amount of the cross-linking accelerator is 200 parts by weight or less per 100 parts by weight of Component (a) with the proviso that, where the resin composition contains Component (e), a total with the amount of Component (e) is 200 parts by weight or less per 100 parts by weight of Component (a). In other words, a total amount of the cross-linking accelerators present in the thermoplastic elastomer composition shall be 200 parts by weight or less per 100 parts by weight of Component (a). Preferably, the aforesaid total amount is 0.3 to 200 parts by weight, more preferably 0.3 to 150 parts by weight, still more preferably 0.5 to 80 parts by weight, per 100 parts by weight of Component (a). Too high the amount of the cross-linking accelerator decreases the flowability of the thermoplastic elastomer composition obtained, which makes the production and molding difficult, and makes worse whitening on bending, fatigue on bending and breeding-out of oil as well as compression set.

It is preferred for decreased hard spots in a shaped article that the cross-linking accelerator is incorporated as Component (e) in the resin composition. This may be added during the production of the thermoplastic elastomer composition instead of being incorporated in the resin composition. Alternatively, a part of the cross-linking accelerator may be incorporated as Component (e) in the resin composition, and the remaining part are be added during the production of the thermoplastic elastomer composition.

The thermoplastic elastomer composition according to the present invention may further comprise, if required, a non-aromatic softening agent for rubber. The non-aromatic softening agent for rubber is used for the purpose of providing flexibility to the thermoplastic elastomer composition and improving molding processability. Examples of the non-aromatic softening agent for rubber include those described as Component (c) of the aforesaid resin composition.

The amount of the aforesaid non-aromatic softening agent for rubber is 800 parts by weight or less, preferably 600 parts by weight or less, more preferably 500 parts by weight or less, per 100 parts by weight of the rubber. Also the aforesaid amount is preferably at least 1 part by weight, per 100 parts by weight of the rubber. If the amount exceeds the aforesaid upper limit, breeding-out tends to occur on the surface of a shaped article prepared from the thermoplastic elastomer composition obtained.

The thermoplastic elastomer composition according to the present invention may further comprise, if required, at least one polymer selected from the group consisting of copolymers of a vinyl aromatic compound with a conjugated diene compound, hydrogenated copolymers obtained by hydrogenating those copolymers, and hydrogenated polymers obtained by hydrogenating polymers of a conjugated diene compound. The aforesaid polymer is used for retaining paraffin oil and adjusting flexibility of the thermoplastic elastomer composition obtained. Examples of the aforesaid polymer include those described as Component (d) in the aforesaid resin composition.

The amount of the aforesaid polymer is 200 parts by weight or less, preferably 120 parts by weight or less, per 100 parts by weight of the rubber. Also the aforesaid amount is preferably at least 3 parts by weight, more preferably at least 5 parts by weight, per 100 parts by weight of the rubber. If it exceeds the aforesaid upper limit, compression set of the thermoplastic elastomer composition obtained will be worse.

The thermoplastic elastomer composition according to the present invention may further comprise, if required, an organic peroxide. The organic peroxide is used for the purpose of further improving the compression set of the thermoplastic elastomer composition obtained.

The organic peroxides may be, for example, 1,1-bis(t-hexylperoxy)-3,3,5-trimethylcyclohexane, 1,1-bis(t-butylperoxy)-3,3,5-trimethylcyclohexane, benzoylperoxide, m-methylbenzoylperoxide, m-toluoylperoxide, t-hexylperoxybenzoate, 1,1-bis(t-butylperoxy)-2-methylcyclohexane, 1,1-bis(t-hexylperoxy)cyclohexane, 1,1-bis(t-butylperoxy)cyclohexane, 2,2-bis(4,4-dibutylperoxycyclohexyl)propane, 1,1-bis(t-butylperoxy)cyclododecane, t-hexylperoxyisopropylmonocarbonate, succinic acid peroxide, 1-cyclohexyl-1-methyethylperoxy-2-ethylhexanoate, t-hexylperoxy-2-ethylhexanoate, t-butylperoxy-2-ethylhexanoate, m-toluoyl- and benzoyl-peroxide, t-butylperoxyisobutyrate, t-butylperoxylaurate, 2,5-dimethyl-2,5-di(m-toluoylperoxy)hexane, t-butylperoxyisopropylmonocarbonate, t-butylperoxy-2-ethylhexylmonocarbonate, 2,5-dimethyl-2,5-di(benzoylperoxy)hexane, t-butylperoxyacetate, 2,2-bis(t-butylperoxy)butane, dicumylperoxide, di-tert-butylperoxide, 2,5-dimethyl-2,5-di(tert-butylperoxy)hexane, 2,5-dimethyl-2,5-di(tert-butylperoxy)hexyne-3,1,3-bis(tert-butylperoxyisopropyl)benzene, 1,1-bis(tert-butylperoxy)-3,3,5-trimethylcyclohexane, n-butyl-4,4-bis(tert-butylperoxy)valerate, benzoylperoxide, p-chlorobenzoylperoxide, 2,4-dichlorobenzoylperoxide, tert-butylperoxybenzoate, tert-butylperoxyisopropylcarbonate, diacetylperoxide, lauroylperoxide and tert-butylcumylperoxide.

Among them, preferred are 1,1-bis(t-hexylperoxy)-3,3,5-trimethylcyclohexane (with one-minute half life temperature of 147° C.), 2,5-dimethyl-2,5-di(tert-butylperoxy)hexane (with one-minute half life temperature of 179° C.) and 2,5-dimethyl-2,5-di(tert-butylperoxy)hexyne-3 (with one-minute half life temperature of 194° C.) in terms of odor, discoloration and scorch resistance.

Where the organic peroxide is incorporated in the thermoplastic elastomer composition, the amount is 0.01 to 0.5 part by weight, preferably 0.05 to 0.3 part by weight, per 100 parts by weight of the rubber. If the amount exceeds 0.5 part by weight, decomposition reaction caused by the organic peroxide will be overwhelming to deteriorate compression set of the thermoplastic elastomer composition obtained.

The thermoplastic elastomer composition according to the present invention may further contain a heat stabilizer, an antioxidant, a light stabilizer, a UV stabilizer, a crystallization nucleating agent, an anti-blocking agent, a sealing aid, a release agent such as stearic acid and silicone oil, a slipping agent such as polyethylene wax, colorant, pigment, an inorganic filler (alumina, talc, calcium carbonate, mica, wollastonite and clay), a foaming agent (organic and inorganic), and a flame retardant (a metal hydrate, red phosphorus, ammonium polyphosphate, antimony and silicone) as long as the purpose of the invention is not impeded.

The antioxidant includes phenolic antioxidants such as 2,6-di-tert-p-butyl-p-cresol, 2,6-di-tert-butylphenol, 2,4-dimethyl-6-tert-butylphenol, 4,4-dihydroxydiphenyl and tris(2-methyl-4-hydroxy-5-tert-butylphenyl)butane; phosphite-type antioxidants; and thioether-type antioxidants. Among them, the phenolic antioxidants and the phosphite-type antioxidants are particularly preferred.

As the foaming agent, Expancell (ex Expancell Co.) and Matsumoto-Microsphere (ex Matsumoto Yushi-Seiyaku Co.) are preferred.

### 4. Applications

Since the thermoplastic elastomer composition according to the present invention is superior in compression set in a high temperature range, extrusion moldability and injection moldability, it can be used in the following articles which are molded by blow molding, extrusion molding, injection molding, thermo-forming, elasto-welding, compression molding or the like.

Specifically mentioned are automobile parts include, for example, lighting gaskets, 3D-exchange-blow molded clean air ducts, hood seal hinge covers, belly pans (robot-technology extrusion molded gaskets), cup holders, side brake grips, shift knob covers, seat adjusting knobs, IP skins, flapper door seals, wire harness grommets, rack and pinion boots, suspension cover boots (strut cover boots), glass guides, inner belt line seals, roof guides, trunk lid seals, molded quarter window gaskets, corner moldings, glass encapsulations (robot-technology extrusion molded), hood seals, glass encapsulations (injection molded), glass run channels and secondary seals. As industrial parts, there are specifically mentioned curtain wall gaskets for high-rise buildings, window frame seals, adhesion to metals/fiber reinforcement, parking deck seals, expansion joints, anti-earthquake expansion joints, house window and door seals (for example, co-extrusion molded), house door seals, handrail skins, walking mats (sheets), foot rubbers, washing machine drain hoses (double molded with PP), washing machine lid seals, air conditioner motor mounts, drainpipe seals (double molded with PP), riser tubes, pipe (made of PVC) joint packings, caster wheels, printer rolls, duct hoses, wires and cables, and syringe gaskets. Further, as commodity goods or parts, mentioned are speaker surrounds, hair brush grips, razor grips, cosmetic container grips and feet, toothbrush grips, commodity brush grips, broom bristles, kitchen ware grips, measuring spoon grips, pruning shears grips, heat resistant glass ware lids, gardening ware grips, scissors grips, stapler grips, computer mice, golf bag parts, trowel grips, chain saw grips, screw driver drips, hammer grips, power drill grips, grinder grips and alarm clocks.

As other specific applications, there are mentioned vehicle parts such as weather seals, brake parts such as cups, coupling disks and diaphragm cups, boots such as constant velocity joints and rack transmission joints, tubing, sealing gaskets, parts of hydraulically or pneumatically operated apparatus, O-rings, pistons, valves, valve seats, valve guides, and other elastomeric polymer based-parts or elastomeric polymers combined with other materials such as combined metal/plastic materials, V-belts, toothed belts with truncated ribs containing fabric faced V's and transmission belts comprising molded rubber with ground short fiber reinforced V's or short fiber flocked V's

The present invention will now be elucidated by referring to the Examples and Comparative Examples without being limited thereto. Test methods and materials used in the Examples and Comparative Examples are as follows.

### 1. Test Methods

(1) Specific gravity: This test was performed according to JIS (Japanese Industrial Standards) K 7112 on a specimen of a compression molded sheet of 1 mm thick.

(2) Hardness: This test was performed according to JIS K 7215 on a specimen of a compression molded sheet of 6.3 mm thick with a Durometer hardness, type D.

(3) Anti-Blocking Resistance: 200 g of pellets of the resin composition were placed in a container. A disk-shaped weight of 500 g with a 70 mm diameter was set on top of the pellets and they were left at room temperature (23° C.) for 168 hours, whereupon the state of the pellets was observed to rate on the following criteria:

∘: There is no blocking observed among the pellets.

X: There is blocking observed among the pellets.

(4) Lowest temperature to make the production possible: Melt kneading was performed using a twin-screw kneader with an L/D of 30 to produce a resin composition. The lowest melt kneading temperature at which surging due to non-melted Component (b) took place was fined and defined as the lowest possible temperature production.

(5) Productivity: Melt kneading was performed using a twin-screw kneader with an L/D of 30 at the lowest possible production temperature defined in (4) above to produce a resin composition. Load imposed during this process was rated on the following criteria.

∘: There is a margin for the load and stable production is possible.

X: The load is too large to perform stable production.

(6) Shape of the product: The shape of the product was rated on the following criteria.

∘: The product is of a pellet form, allowing easy measurement.

Δ: The product is of a pellet or flake form, allowing easy measurement, but the form is not uniform, accompanied with fine fragments and powder.

X: The product is of a plate or bale shape, making precise measurement difficult.

(7) Handling: Handling of the resin composition was rated on the following criteria.

∘: No dust occurs, and no particular problem occurs in handling.

X: Mush dust occurs to cause serious pollution in the working environment.

(8) Compression set: Compression set of the thermoplastic elastomer composition was measured according to JIS K 6262 under the condition of 25% deformation at 70° C. for 22 hours. A compression molded sheet of 6.3 mm thick was used as a specimen.

(9) Uniformity of cross-linking (the number of hard spots): The thermoplastic elastomer composition was extrusion molded into a sheet of 50 mm×1 mm. The number of hard spots present on the surface in an area of 50 mm×100 mm was counted. The number of hard spots less than 10 was considered good. Less hard spots indicates that more uniform cross-linking took place in the thermoplastic elastomer composition.

(10) Organoleptic test: Ten operators rated, on the following criteria, toxic gases emitted in the melt kneading of the resin composition in a press kneader of a 150 L size to produce a thermoplastic elastomer composition.

∘: Two or less operators complained of pains in eyes, noses or throats caused by the emitted gases.

X: Three or more operators complained of pains in eyes, noses or throats caused by the emitted gases.

### 2. Materials

### Resin Composition

### Component (a):

Tackrol 201 (ex Taoka Chemical Co.), alkylphenol-formaldehyde resin

### Component (b):

(1) Novatec BC08AHA (ex Nippon Polychem Co.), propylene-ethylene block copolymer, density: 0.902 g/cm³, hardness: 94 (Shore A), MFR (230° C., load of 21.18 N): 80 dg/min., weight average molecular weight: 100,000

(2) ENGAGE 8180 (ex DuPont Dow Elastomers Co.), polyethylene polymerized with a metallocene catalyst, density: 0.863 g/cm³, Mooney viscosity (ML₁₊₄, 121° C.): 35, MFR 0.5 g/10 min. (ASTM D 1238, 190° C., load of 2.16 Kg), hardness Shore A: 66, Tm: 49° C., comonomer: octene-1

### Comparative Component (b):

(1) EV150 (ex Mitsui DuPont Polychemical Co.), ethylene-vinyl acetate copolymer (EVA), MFR: 30 dg/min., vinyl acetate content: 33% by weight, tensile strength: 9 MPa

(2) WK307 (ex Sumitomo Chemical Co.), ethylene-methylmethacrylate copolymer (EMMA), density: 0.94 g/cm³, MFR: 7 g/10 min. (JIS K 6730-1981, 190° C., load of 2.16 Kg), hardness Shore A: 90, methylmethacrylate content: 25% by weight

### Component (c)

PW-90 (ex Idemitsu Kosan Co.), n-paraffinic oil, weight average molecular weight: 540, kinetic viscosity at 40° C., 95.54 cSt, kinetic viscosity at 100° C.: 11.25 cSt, pour point: −15° C., flash point (COC): 270° C.

### Component (d)

SEEPS: SEPTON 4077 (ex Kuraray Co.), styrene-ethylene-ethylene-propylene-styrene copolymer, number average molecular weight (Mn): 260,000, weight average molecular weight (Mw): 330,000, styrene content: 30%

### Component (e)

Two types of zinc oxide (ex Sakai Chemical Co.)

### Thermoplastic Elastomer Composition

(1) EPDM: Nordel IP 4770R (ex DuPont Dow Elastomers Co.), ethylene-propylene-5-ethyliden-2-norbornene (ENB) copolymer rubber synthesized with a metallocene catalyst, specific gravity: 0.88, Mooney viscosity ML₁₊₄ (125° C.): 70, weight average molecular weight: 200,000, ethylene: 70%, ENB: 4.9%

(2) PP: Novatec BC08AHA (ex Nippon Polychem Co.), propylene-ethylene block copolymer, density: 0.902 g/cm³, hardness: 94 (Shore A), MFR (230° C., load of 21.18 N): 80 dg/min., weight average molecular weight: 100,000

(3) Paraffin oil: PW-380 (ex Idemitsu Kosan Co.), n-paraffinic oil, weight average molecular weight: 746, kinetic viscosity: 381.6 cSt (40° C.), flash point (COC) 300° C.

(4) SEEPS: SEPTON 4077 (ex Kuraray Co.), styrene-ethylene-ethylene-propylene-styrene copolymer, number average molecular weight (Mn): 260,000, weight average molecular weight (Mw): 330,000, styrene content: 30%

(5) Organic peroxide: Perhexa 25B (ex Nippon Fats & Oils Co.), 2,5-dimethyl-2,5-di(t-butylperoxy)-hexane

(6) Zinc oxide: two types of zinc oxide (ex Sakai Chemical Co.)

### EXAMPLES

### Examples 1 to 3 and Comparative Examples 1 to 10

The components in the amounts (parts by weight) as shown in Table 1 were melt kneaded with a twin-screw kneader of L/D=30 at the lowest possible production temperature shown in Table 1 to obtain a resin composition, followed by pelletization. The pellets obtained were compression molded into test specimens, which were then subjected to the aforesaid tests (1) to (7). In place of the resin composition, use was made of a phenolic resin consisting solely of Component (a) of the present invention (trade name: Tackirol 201) in Comparative Example 7, and a masterbatch comprising a phenolic resin and butyl rubber (trade name: Tackrol 201 MB35; consisting of 35% by weight of butyl rubber, 30% by weight of non-brominated phenolic resin and 35% by weight of clay) in Comparative Example 8. The results are as shown in Table 1.

TABLE 1
Resin compositions

| | | Exam- | Exam- | Exam- | Comp. | Comp. | Comp. | Comp. | Comp. | Comp. | Comp. | Comp. | Comp. | Comp. |
|---|---|---|---|---|---|---|---|---|---|---|---|---|---|---|
| | | ple 1 | ple 2 | ple 3 | Ex. 1 | Ex. 2 | Ex. 3 | Ex. 4 | Ex. 5 | Ex. 6 | Ex. 7 | Ex. 8 | Ex. 9 | Ex. 10 |
| Compo- | (a) Tackirol | 100 | 100 | 100 | 100 | 100 | 100 | 100 | 100 | 100 | | | 100 | 100 |
| nents | 201 | | | | | | | | | | | | | |
| | (b) BC08AHA | 100 | 100 | | 10 | 550 | 100 | 100 | 100 | 100 | | | | |
| | (b) | | | 100 | | | | | | | | | | |
| | ENGAGE8180 | | | | | | | | | | | | | |
| | Comparative | | | | | | | | | | | | 100 | |
| | component (b) | | | | | | | | | | | | | |
| | EV150 | | | | | | | | | | | | | |
| | Comparative | | | | | | | | | | | | | 100 |
| | component (b) | | | | | | | | | | | | | |
| | WK307 | | | | | | | | | | | | | |
| | (c) PW-90 | 100 | 100 | 100 | 100 | 100 | 10 | 350 | 100 | 100 | | | 100 | 100 |
| | (d) SEPTON | 50 | 50 | 50 | 50 | 50 | 50 | 50 | 5 | 200 | | | 50 | 50 |
| | 4077 | | | | | | | | | | | | | |
| | (e) Zinc oxide | | 20 | | | | | | | | | | | |
| | Phenol resin | | | | | | | | | | 100 | | | |
| | Masterbatch | | | | | | | | | | | 290 | | |
| | comprising | | | | | | | | | | | | | |
| | phenol | | | | | | | | | | | | | |
| | resin and butyl | | | | | | | | | | | | | |
| | rubber | | | | | | | | | | | | | |
| Results | Specific gravity | 0.95 | 0.95 | 0.92 | 0.95 | 0.93 | 0.96 | 0.94 | 0.95 | 0.94 | — | — | 0.91 | 0.96 |
| of | Hardness | 50 | 51 | 25 | 35 | 67 | 59 | 23 | 53 | 46 | — | — | 32 | 41 |
| rating | (Shore D) | | | | | | | | | | | | | |
| | Blocking | ◯ | ◯ | ◯ | X | ◯ | ◯ | X | ◯ | ◯ | — | — | X | X |
| | resistance | | | | | | | | | | | | | |
| | Lowest | 180 | 180 | 100 | 180 | 180 | 175 | 190 | 260 | 175 | — | — | 100 | 100 |
| | possible | | | | | | | | | | | | | |
| | production | | | | | | | | | | | | | |
| | temperature | | | | | | | | | | | | | |
| | Producibility | ◯ | ◯ | ◯ | ◯ | ◯ | X | ◯ | ◯ | X | — | — | ◯ | ◯ |
| | (load) | | | | | | | | | | | | | |
| | Shape of the | ◯ | ◯ | ◯ | Δ | ◯ | ◯ | ◯ | ◯ | ◯ | Δ | X | ◯ | ◯ |
| | product | | | | | | | | | | | | | |
| | Handling | ◯ | ◯ | ◯ | ◯ | ◯ | ◯ | ◯ | ◯ | ◯ | X | ◯ | ◯ | ◯ |

### Examples 4 to 9 and Comparative Examples 11 to 20

Using the resin compositions obtained in Examples 1 to 3 and Comparative Examples 1 to 10, the thermoplastic elastomer compositions were produced in Examples 4 to 9 and Comparative Examples 11 to 20. The formulations of the thermoplastic elastomer compositions are as shown in Table 2. In place of the resin composition, use was made of a phenolic resin consisting solely of Component (a) of the present invention (trade name: Tackirol 201) in Comparative Example 17, and a masterbatch comprising a phenolic resin and butyl rubber (trade name: Tackirol 201 MB35; comprising 35% by weight of butyl rubber, 30% by weight of non-brominated phenolic resin and 35% by weight of clay) in Comparative Example 18. The production was carried out by charging the components of the amounts (parts by weight) shown in Table 2 into a press kneader type mixer of a capacity of 3 L and melt kneading them at a temperature set at 180° C. for 10 minutes. The thermoplastic elastomer compositions obtained were subjected to the aforesaid tests (8) to (10). The results are as shown in Table 2.

TABLE 2
Thermoplastic elastomer compositions

| | | Example 4 | Example 5 | Example 6 | Example 7 | Example 8 | Example 9 |
|---|---|---|---|---|---|---|---|
| Components | EPDM (1) | 100 | 100 | 100 | 100 | 100 | 100 |
| | PP (2) | 100 | 100 | 100 | 100 | 100 | 100 |
| | Paraffin oil (3) | 120 | 120 | 120 | 120 | 120 | 120 |
| | Resin composition | 35 | 37 | 35 | 35 | 35 | 35 |
| | | (Composition | (Composition | (Composition | (Composition | (Composition | (Composition |
| | | of Example 1) | of Example 2) | of Example 3) | of Example 1) | of Example 1) | of Example 1) |
| | Phenol resin | | | | | | |
| | Masterbatch comprising phenol | | | | | | |
| | resin and butyl rubber | | | | | | |
| | SEEPS (4) | | | | 30 | 30 | |
| | Organic peroxide (5) | | | | | 0.1 | |
| | Zinc oxide (6) | | | | | | 2 |
| Evaluation | Compression set (70° C. 22 h) (%) | 30 | 26 | 33 | 27 | 25 | 23 |
| | Uniformity in crosslinking | 3 | 8 | 4 | 3 | 5 | 6 |
| | (the number of hard spots) | | | | | | |
| | Organoleptic test (gases emitted) | ◯ | ◯ | ◯ | ◯ | ◯ | ◯ |

| | | Comp. Ex. 11 | Comp. Ex. 12 | Comp. Ex. 13 | Comp. Ex. 14 | Comp. Ex. 15 |
|---|---|---|---|---|---|---|
| Components | EPDM (1) | 100 | 100 | 100 | 100 | 100 |
| | PP (2) | 100 | 100 | 100 | 100 | 100 |
| | Paraffin oil (3) | 120 | 120 | 120 | 120 | 120 |
| | Resin composition | 26 | 80 | 26 | 60 | 30.5 |
| | | (Composition | (Composition | (Composition | (Composition | (Composition |
| | | of Comp. Ex. 1) | of Comp. | of Comp. | of Comp. | of Comp. Ex. 5) |
| | | | Ex. 2) | Ex. 3) | Ex. 4) | |
| | Phenol resin | | | | | |
| | Masterbatch comprising phenol | | | | | |
| | resin and butyl rubber | | | | | |
| | SEEPS (4) | | | | | |
| | Organic peroxide (5) | | | | | |
| | Zinc oxide (6) | | | | | |
| Evaluation | Compression set (70° C. 22 h) (%) | 27 | 55 | 30 | 32 | 48 |
| | Uniformity in crosslinking (the number of hard | 5 | 3 | 5 | 4 | 3 |
| | spots) | | | | | |
| | Organoleptic test (gases emitted) | ◯ | ◯ | ◯ | ◯ | ◯ |
| | | Comp. Ex. 16 | Comp. Ex. 17 | Comp. Ex. 18 | Comp. Ex. 19 | Comp. Ex. 20 |
| Components | EPDM (1) | 100 | 100 | 100 | 100 | 100 |
| | PP (2) | 100 | 100 | 100 | 100 | 100 |
| | Paraffin oil (3) | 120 | 120 | 120 | 120 | 120 |
| | Resin composition | 50 | | | 35 | 35 |
| | | (Composition | | | (Composition | (Composition |
| | | of Comp. Ex. 6) | | | of Comp. | of Comp. Ex. 10) |
| | | | | | Ex. 9) | |
| | Phenol resin | | 10 | | | |
| | Masterbatch comprising phenol | | | 29 | | |
| | resin and butyl rubber | | | | | |
| | SEEPS (4) | | | | | |
| | Organic peroxide (5) | | | | | |
| | Zinc oxide (6) | | | | | |
| Evaluation | Compression set (70° C. 22 h) (%) | 33 | 28 | 38 | 46 | 44 |
| | Uniformity in crosslinking (the number of hard | 4 | 45 | 36 | 12 | 10 |
| | spots) | | | | | |
| | Organoleptic test (gases emitted) | ◯ | X | ◯ | ◯ | ◯ |

As seen from Table 1, the resin compositions of Examples 1 to 3 according to the present invention could be easily kneaded in a twin-screw kneader at a lower kneading temperature and could be pelletized. The pellets obtained showed no blocking and caused no dust in handling. As seen from Table 2, the resin compositions according to the present invention could yield more uniform cross-linking and, at the same time, could improve compression set of the thermoplastic elastomer compositions obtained and emitted less toxic gases during the production of the thermoplastic elastomer compositions, so that the resin compositions are useful as a masterbatch of a cross-linking agent.

On the other hand, the amount of Component (b), (c) or (d) in the formulations is outside the ranges of the present invention in the resin compositions of Comparative Examples 1 to 6. As seen from Table 1, the resin composition of Comparative Example 1 where the amount of Component (b) is below the range of the present invention and the resin composition of Comparative Example 4 where the amount of Component (c) exceeds the range of the present invention were both able to be produced and pelletized, but caused blocking of pellets, leading to a trouble in handling such that the blocked pellets had to be broken up to be used as a masterbatch of a cross-linking agent. The resin composition of Comparative Example 2 where the amount of Component (b) exceeds the range of the present invention results, as seen from Table 2, in the inferior compression set of the thermoplastic elastomer composition obtained from it (see Comparative Example 12). Both in the resin composition of Comparative Example 3 where the amount of Component (c) is below the range of the present invention and the resin composition of Comparative Example 6 where the amount of Component (d) exceeds the range of the present invention, the load during the production of the resin composition tended to exceed the upper limit of load of the kneader, which made stable production difficult to attain. The resin composition of Comparative Example 5 where the amount of Component (d) is below the range of the present invention has the lowest possible production temperature of 260° C. and, as a result, the thermoplastic elastomer composition obtained from it is inferior in compression set as seen from Table 2, Comparative Example 15. This indicates that because the resin composition of Comparative Example 5 was produced at a higher temperature, the phenolic resin deteriorated and, as a consequence, the cross-linking ability of the resin composition became worse.

In Comparative Examples 7 and 17, the phenolic resin alone was used in place of the resin composition of the present invention. The phenolic resin was of hard and brittle masses, whose shape was irregular, accompanied with a large amount of crumbled powder. Therefore, non-uniformity in composition tended to occur in the blending of the components of the thermoplastic elastomer composition. In addition, because the phenolic resin was hard and brittle, dust occurred in the handling. Further, as seen in Table 2, uniform cross-linking was not attained in the obtained thermoplastic elastomer compositions and the toxic gases occurred during the production of the thermoplastic elastomer composition.

In Comparative Examples 8 and 18, the phenolic resin masterbatch comprising butyl rubber was used in place of the resin composition of the present invention. The masterbatch comprising butyl rubber was of a tile form and can not be palletized. It had to be cut in pieces with a guillotine cutter before used, which took much time and works. In addition, as seen in Table 2, uniform cross-linking was not obtained with the masterbatch comprising butyl rubber.

In Comparative Examples 9 and 10, comparative Components (b), i.e., ethylene-vinyl acetate copolymer and ethylene-methylmethacrylate copolymer were used, respectively. As seen from Table 1, the anti-blocking property was poorer. The thermoplastic elastomer compositions obtained from the resin compositions of Comparative Examples 9 and 10 were, as seen from Table 2, inferior in compression set and the shaped articles therefrom had many hard spots (see Comparative Examples 19 and 20).

1. A resin composition comprising
(a) 100 parts by weight of at least one compound selected from the group consisting of phenolic resin and brominated phenolic resins,
(b) 20 to 500 parts by weight of a crystalline olefine resin other than copolymers of ethylene with an unsaturated carboxylic acid ester or with vinyl acetate,
(c) 20 to 300 parts by weight of a non-aromatic softening agent for rubber, and
(d) 10 to 100 parts by weight of at least one polymer selected from the group consisting of a copolymer of a vinyl aromatic compound with a conjugated diene compound, a hydrogenated copolymer obtained by hydrogenating said copolymer, and a hydrogenated polymer obtained by hydrogenating a polymer of a conjugated diene compound.

2. A resin composition according to claim 1, wherein the component (b) is at least one selected from the group consisting of an ethylene homopolymer, a propylene homopolymer, an ethylene-α-olefin copolymer, and a propylene-α-olefin copolymer.

3. A resin composition according to claim 1, wherein the component (a) is an alkylphenol-formaldehyde resin.

4. A resin composition according to claim 1, wherein it further comprises (e) a cross-linking accelerator in an amount of 200 parts by weight or less.

5. A cross-linked elastomer composition comprising 100 parts by weight of rubber and 1 to 200 parts by weight of the resin composition according to claim 1.

6. A composition according to claim 5, wherein it further comprises a crystalline olefine resin in an amount of 400 parts by weight or less.

7. A composition according to claim 5, wherein it further comprises a cross-linking accelerator in an amount of 200 parts by weight or less per 100 parts by weight of component (a) with the proviso that, when the resin composition comprises Component (e), a total with the amount of Component (e) is 200 parts by weight or less per 100 parts by weight of Component (a).

8. A composition according to claim 5, wherein it further comprises a non-aromatic softening agent for rubber in an amount of 800 parts by weight or less.

9. A composition according to claim 5, wherein it further comprises at least one polymer selected from the group consisting of a copolymer of a vinyl aromatic compound with a conjugated diene compound, a hydrogenated copolymer obtained by hydrogenating said copolymer, and a hydrogenated polymer obtained by hydrogenating a polymer of a conjugated diene compound in an amount of 200 parts by weight or less.

10. A composition according to claim 5, wherein it further comprises 0.01 to 0.5 part by weight of an organic peroxide.
